(19) United States
(12) Patent Application Publication
(10) Pub. No.: US 2026/0188931 A1
(43) Pub. Date: Jul. 2, 2026

(54) ELECTRICAL CONNECTOR WITH IMPROVED RELIABILITY AND FLEXIBILITY FOR SYSTEM APPLICATIONS

(71) Applicant: Amphenol East Asia Electronic Technology (Shenzhen) Co., Ltd., Shenzhen (CN)

(72) Inventors: Zhimin Qin, Shenzhen (CN); Fei Wu, Shenzhen (CN); Kangqin Li, Shenzhen (CN); Zefeng Lai, Shenzhen (CN); Huiwen Liu, Shenzhen (CN)

(73) Assignee: Amphenol East Asia Electronic Technology (Shenzhen) Co., Ltd., Shenzhen (CN)

(21) Appl. No.: 19/418,031

(22) Filed: Dec. 12, 2025

(30) Foreign Application Priority Data
Dec. 31, 2024 (CN) 202423317195.0

(51) Int. Cl. H01R 12/75; H01R 12/70; H01R 12/72; H01R 43/18

(52) U.S. Cl. CPC H01R 12/75; H01R 12/7047; H01R 12/722; H01R 43/18

(57) ABSTRACT

Electrical connector with improved reliability and flexibility for system applications. An electrical connector includes one or more chambers formed between a top shell and a bottom shell. Each chamber can receive a subassembly including a subassembly housing holding terminals and a shield. The terminals comprise contact tails configured for pressure mount. An inner shell is disposed around the tongue portion of the subassembly housing and has position assurance features. The top and bottom shells can be welded together and to the inner shell. Such a configuration can improve the strength of the connector. The top shell can be manufactured by processing a metal sheet to form recesses, openings, etc. at selected locations, and then stamping the processed metal sheet into the desired shape for the top shell. Such a connector can be mounted above a circuit board, below a circuit board, and in a belly-to-belly configuration.

### CROSS-REFERENCE TO RELATED APPLICATION

This application claims priority to and benefit of Chinese Patent Application No. 202423317195.0, filed Dec. 31, 2024. The contents of this application are incorporated herein by reference in their entirety.

### FIELD

This application relates to interconnection systems, such as those including electrical connectors, configured to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components. Electrical connectors are used in a wide range of applications including electronics (e.g., 5G phones, e-cigarettes, computers), communications technology (e.g., telecommunication apparatus, networking apparatus, routing devices), vehicles, aerospace, etc.

A known arrangement for joining several electronic subassemblies is to have one printed circuit board serve as a backplane. A known backplane is a PCB onto which many connectors may be mounted. Conducting traces in the backplane may be electrically connected to signal conductors in the connectors such that signals may be routed between the connectors. Other printed circuit boards, called “daughterboards,” “daughtercards,” or “midboards,” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore include a right angle bend and are often called “right angle connectors.”

Connectors may also be used in other configurations for interconnecting electronic assemblies. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

Connectors may also be used in computers in which the motherboard might have a processor and a bus configured to pass data between the processor and peripherals, such as a printer or memory device. Connectors may be mounted to the motherboard and connected to the bus. A mating interface of those connectors may be exposed through an opening in the enclosure for the computer, such that connectors, often attached to the peripheral through a cable, may be inserted into the connectors on the motherboard. With this configuration, a peripheral can be easily connected to a computer.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus that is compliant with the standard. Examples of such standards include universal serial bus (USB), which is commonly used in computers. The standards have gone through multiple revisions, adapting to the higher performance expected from computers over time. For example, portable electronic devices often include USB Type-C receptacle connectors for various purposes such as charging and/or exchanging data with another electronic device by connecting the USB receptacle connector with a USB plug connector.

### BRIEF SUMMARY

Aspects of the present disclosure relate to electrical connector assemblies with improved reliability and flexibility for system applications.

Some embodiments relate to a shell for a connector. The shell may comprise a base portion configured to mount to a circuit board; and a raised portion having a height with respect to the base portion, the raised portion comprising one or more recesses configured for joining with an inner shell of the connector.

Optionally, the height is in a range of 2.4 mm to 3.4 mm.

Optionally, the raised portion comprises a front subportion having a first width in a direction perpendicular to a mating direction of the connector, and a rear subportion having a second width in the direction perpendicular to the mating direction of the connector, the first width greater than the first width, a transition subportion connecting the front subportion and the rear subportion.

Optionally, the raised portion is a first raised portion; and the shell comprises a second raised portion separated from the first raised portion by a subportion of the first raised portion.

Optionally, the subportion of the base portion comprises a threaded hole.

Optionally, the subportion of the base portion comprises a rib connecting the first raised portion and the second raised portion.

Optionally, the shell comprises stainless steel having a thickness in a range of 0.5 mm to 2.0 mm.

Optionally, the shell is thinner at the one or more recesses than non-recessed portions.

Some embodiments relate to an electrical connector. The electrical connector may comprise a top shell comprising a base portion and a raised portion protruding from the base portion; a bottom shell connected to the base portion of the top shell; a chamber between the raised portion and the bottom shell; and a connector subassembly disposed in the chamber.

Optionally, the connector subassembly comprising a mating interface compliant with a USB Type-C standard in effect on or before the priority date of the present disclosure.

Optionally, the connector subassembly comprises a terminal assembly comprising a plurality of terminals, each of the plurality of terminals comprising a mating end, a contact tail configured to establish pressure-mount electrical connections, and an intermediate portion between the mating end and the contact tail; a shield; and a subassembly housing holding the plurality of terminals and the shield.

Optionally, the plurality of terminals comprise one or more signal terminals; and the intermediate portion of each of the one or more signal terminals comprises a slot aligned with an opening of the shield.

Optionally, the shield comprises a lug portion extending beyond the subassembly housing and disposed between and joined with the base portion of the top shell and the bottom shell.

Optionally, the connector subassembly comprises an inner shell surrounding at least the mating ends of the plurality of terminals; and the inner shell is disposed between and joined with the raised portion of the top shell and the bottom shell.

Optionally, the inner shell is welded to the raised portion of the top shell and the bottom shell at selected locations.

Optionally, the inner shell comprises one or more protrusions engaging with the subassembly housing of the terminal assembly, and one or more beams configured to abut against a mating component to the terminal assembly.

Some embodiments relate to a method for manufacturing a shell for a connector. The method comprises providing a metal sheet; processing the metal sheet to form one or more recesses on the metal sheet; and stamping the processed metal sheet into the shell comprising a base portion and a raised portion spaced from the base portion and connected to the base portion on at least two sides.

Optionally, the metal sheet is a stainless steel sheet having a thickness in a range of 0.5 mm to 2.0 mm.

Optionally, the metal sheet is processed by corrosion, etching, laser processing, and/or stamping and punching to form the one or more recesses.

Optionally, the method comprises forming a threaded hole in the base portion of the shell.

Some embodiments relate to a top shell for an electrical connector. The top shell may comprise: a base portion connected to a circuit board; and a raised portion protruding from the base portion to form a chamber for accommodating an inner shell for the electrical connector.

Optionally, the raised portion may have a plurality of recesses on an upper surface of the raised portion.

Optionally, a protruding height of the raised portion may be equal to or less than 3.4 mm.

Optionally, the base portion may be formed with a hole penetrating in a thickness direction of the base portion.

Optionally, a thread may be formed on an inner wall face of the hole.

Optionally, the raised portion may comprise: a front subportion, a rear subportion, and a transition subportion connecting the front subportion and the rear subportion, wherein a width of the front subportion in a length direction of the electrical connector is smaller than a width of the rear subportion in the length direction of the electrical connector.

Optionally, the top shell for the electrical connector may comprise a plurality of raised portions configured to be spaced apart.

Optionally, all of the plurality of raised portions may have an identical structure.

Optionally, the base portion may be formed on both sides of the raised portion in a length direction of the electrical connector, and one or more holes are formed on each of the base portions.

Optionally, a rib extending along a length direction of the electrical connector may be formed on the base portion between every two of the raised portions.

Optionally, the top shell may be made of a stainless steel sheet of SUS316 or SUS304.

Optionally, the stainless steel sheet may have a thickness in a range of 0.5 mm to 2.0 mm.

Optionally, the raised portion may be formed by stretching and cold forging a stainless steel plate.

Some embodiments relate to an electrical connector. The electrical connector may comprise: a top shell; a bottom shell, wherein the bottom shell is connected to the top shell to form one or more chambers; and a connector subassembly accommodated in the chamber.

Optionally, the top shell may comprise: a base portion connected to a circuit board; and one or more raised portions protruding from the base portion, the raised portions cooperating with the bottom shell to form the chamber.

Optionally, the raised portion may have a plurality of recesses on an upper surface of the raised portion.

Optionally, a protruding height of the raised portion may be equal to or less than 3.4 mm.

Optionally, the base portion may be formed with a hole penetrating in a thickness direction of the base portion.

Optionally, a thread may be formed on an inner wall face of the hole.

Optionally, the raised portion may comprise: a front subportion, a rear subportion, and a transition subportion connecting the front subportion and the rear subportion, wherein a width of the front subportion in a length direction of the electrical connector is smaller than a width of the rear subportion in the length direction of the electrical connector.

Optionally, each of the one or more chambers comprises a front subchamber and a rear subchamber, the front subchamber being formed by enclosing an inner surface of the front subportion and an upper surface of the bottom shell together; the rear subchamber being formed by an inner surface of the rear subportion.

Optionally, the base portion may be formed on both sides of each of the one or more chambers in the length direction of the electrical connector, and one or more holes may be formed on each of the base portions.

Optionally, a rib extending along a length direction of the electrical connector may be formed on the base portion between every two of the raised portions.

Optionally, the top shell may be made of a stainless steel sheet of SUS316 or SUS304.

Optionally, the stainless steel sheet may have a thickness in a range of 0.5 mm to 2.0 mm.

Optionally, the raised portion may be formed by stretching and cold forging a stainless steel plate.

Optionally, the connector subassembly may comprise a terminal assembly comprising a plurality of terminals provided to be spaced apart along a length direction of the electrical connector and configured to establish pressure-mount electrical connections.

Optionally, the connector subassembly may further comprise a shield and a subassembly housing configured to accommodate the plurality of terminals and the shield.

Optionally, the plurality of terminals may comprise mating ends and tail ends, the tail ends each being provided with an elastic bending portion which protrudes towards a direction opposite to the top shell in such a manner that the elastic bending portion can be elastically deformed in a protruding direction of the raised portion.

Optionally, the mating ends of the plurality of terminals may be provided on a tongue portion of the subassembly housing, and may be provided in two rows along a protruding direction of the raised portion, and the tail ends of the plurality of terminals extend beyond rear ends of the subassembly housing.

Optionally, the elastic bending portion of one or more of the plurality of terminals may be provided with a slot; an opening may be formed on the shield, and the slot is aligned with the opening when the terminal assembly and the shield are mounted on the subassembly housing.

Optionally, the shield may comprise a lug portion, which extends beyond two opposite side portions of the rear end of the subassembly housing in the length direction, and is adapted for connection with the top shell.

Optionally, the connector subassembly may further comprise an inner shell adapted to connect with the top shell and the bottom shell, the inner shell being configured to surround the tongue portion of the subassembly housing.

Optionally, the inner shell may be accommodated in the chamber, and may be welded to the raised portion and the bottom shell constituting the chamber.

Optionally, the inner shell may comprise one or more stopping portions provided on an inner surface of the inner shell, and the stopping portion abuts against an end of a plug inserted into the electrical connector.

Optionally, the inner shell may comprise one or more beams and/or one or more protrusions provided on an inner surface of the inner shell, and the plug inserted into the electrical connector is clamped by the beam.

Optionally, the connector subassembly may have a mating interface that complies with the USB Type-C standard.

Some embodiments relate to a method of manufacturing a top shell for an electrical connector. The method may comprise: providing a metal sheet; stamping a processed metal sheet to form a top shell having a base portion and a raised portion, wherein the raised portion protrudes from the base portion to form a chamber for accommodating an inner shell for the electrical connector.

Optionally, the metal sheet may be a stainless steel sheet, and the metal sheet may have a thickness in a range of 0.5 mm to 2.0 mm.

Optionally, the method may further comprise processing the raised portion to form a recess on the raised portion.

Optionally, the metal sheet is processed by methods of corrosion, etching, laser processing, stamping and punching and/or other shaping techniques to form the plurality of recesses on the metal sheet.

Optionally, a protruding height of the raised portion may be equal to or less than 3.4 mm.

Optionally, a hole penetrating in a thickness direction of the base portion may be formed in the base portion by a reverse drawing process, and a thread may be formed on an inner wall face of the hole.

These techniques may be used alone or in any suitable combination. The foregoing summaries are provided by way of illustration and are not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a perspective view of an electrical connector, according to some embodiments.

FIG. 1B is a perspective view of an electrical connector, according to some embodiments.

FIG. 2A is a partially exploded perspective view of the electrical connector of FIG. 1A.

FIG. 2B is a partially exploded perspective view of the electrical connector of FIG. 1B, according to some embodiments.

FIG. 2C is a partially exploded perspective view of the electrical connector of FIG. 1B, according to some embodiments.

FIG. 3A is a top perspective view of a top shell of the electrical connector of FIG. 1A.

FIG. 3B is a bottom perspective view of the top shell of FIG. 3A.

FIG. 4A is a top perspective view of a top shell of the electrical connector of FIG. 1B.

FIG. 4B is a bottom perspective view of the top shell of FIG. 4A.

FIG. 5A is a top perspective view of the electrical connector of FIG. 1A.

FIG. 5B is a bottom perspective view of the electrical connector of FIG. 5A.

FIG. 6A is a top perspective view of the electrical connector of FIG. 1B.

FIG. 6B is a bottom perspective view of the electrical connector of FIG. 6A.

FIGS. 7A to 7C are perspective views of an inner shell of the electrical connector of FIG. 1A, viewed from various directions.

FIG. 8 is a partially exploded perspective view of the electrical connector of FIG. 1A.

FIG. 9A is a top perspective view of a connector subassembly of the electrical connector of FIG. 1A.

FIG. 9B is a bottom perspective view of the connector subassembly of FIG. 9A.

FIG. 10A is a top perspective view of terminals and shields of the connector subassembly of FIG. 9A.

FIG. 10B is a bottom perspective view of the terminals and shields of FIG. 10A.

### DETAILED DESCRIPTION

The inventors have recognized and appreciated connector design techniques for making connector assemblies that provide a mating interface compliant with an industry standard, such as USB Type-C, while offering improved reliability and flexibility for system application. Conventionally, electrical connector shells are made relatively thick to satisfy mechanical strength requirements and are typically manufactured by powder metallurgy, which limits the ability to incorporate threaded features. In addition, conventional surface mounting technology (SMT) complicates replacement of terminal components, and may lead to degraded electrical contact performance. Also, components are often connected through snap-fit features, which may disengage under stress or vibration and cause malfunction.

According to aspects of the present disclosure, a connector may include one or more chambers formed between a top shell and a bottom shell. The top and bottom shells may be welded together and/or to an inner shell. Such a configuration can improve the strength of the connector. The top shell can be manufactured by processing a metal sheet to form recesses, openings, etc. at selected locations, and then stamping the processed metal sheet into the desired shape for the top shell.

Each chamber may receive a subassembly. The subassembly may include one or more rows of terminals and a shield. The shield may be disposed between adjacent rows of terminals. A subassembly housing may hold the terminals and shield such that mating ends of the terminals disposed on opposite sides of a tongue portion of the subassembly housing, and tail ends of the terminals extending out of the bottom of the subassembly housing. The tail ends of the terminals may include contact tails configured for pressure mount.

The terminals may include signal terminals disposed in pairs. Each signal terminal may include a bent region having a slot aligned with an opening of the shield. Such a configuration can improve signal integrity (SI) performance. The shield may include side portions extending out of opposite sides of the subassembly housing and configured to mount to the circuit board. The inner shell may be disposed around the tongue portion of the subassembly housing and have position assurance features.

The connector can be mounted above a circuit board, below a circuit board, and in a belly-to-belly configuration (one connector above a board and another connector below a board substantially aligned with the one above the board). The connector can have a height configured according to system requirements (e.g., a height up to 3.40 mm such a height in a range of 2.40 mm to 3.40 mm).

In some embodiments, the top shell is provided with a base portion connected to a circuit board, and a raised portion protruding from the base portion to form a chamber for accommodating an inner shell for the electrical connector. Such a configuration of the top shell can enable the obtained electrical connector to be mounted not only above or below a circuit board, but also in a circuit board of a belly-to-belly configuration. In the belly-to-belly configuration, one electrical connector is mounted above the circuit board, while another electrical connector is mounted below the circuit board and is substantially aligned with the electrical connector above the circuit board. On the one hand, with the top shell, a raised portion is provided to form a chamber for accommodating the inner shell for the electrical connector, thereby ensuring the reliability of the electrical connector in terms of mechanical and electrical connections. On the other hand, such a configuration of the top shell is suitable for both scenarios in which it is mounted above or below a circuit board and scenarios in which it is mounted in a belly-to-belly configuration, thereby significantly increasing the flexibility of application scenarios for the electrical connector.

In some embodiments, the protruding height of the raised portion of the top shell may be equal to or less than 3.4 mm. In this way, the connector may be mounted in application scenarios in different height spaces within a range of 3.4 mm above the circuit board to 3.4 mm below the circuit board, so that it can be suitable for various application scenarios, further improving the flexibility of the application scenarios of the electrical connector.

In some embodiments, the raised portion of the top shell is provided with a plurality of recesses on the upper surface of the raised portion. The raw material (for example, stainless steel plate) forming the top shell is subjected to special processing (corrosion, etching, laser processing, stamping and punching, and/or other shaping techniques, etc.) to pre-process the special structure of the mold to form a plurality of recesses on the upper surface of the raised portion, so as to reduce the thickness of the top shell at the point where the top shell is welded to the inner shell. The formation of a plurality of recesses on the upper surface of the raised portion of the top shell facilitates spot welding between the top shell and the inner shell and enhances the joint strength between the top shell and the inner shell, thereby ensuring the reliability of the electrical connector in mechanical and electrical connections while meeting the mechanical strength requirements of the shell.

In some embodiments, in order to further ensure the reliability of the mechanical connection, the present application may form the shell using a stamping mold. Accordingly, a hole penetrating in a thickness direction of the base portion may be provided in the base portion of the top shell. In some embodiments, a thread may be formed on an inner wall face of the hole, thereby helping to firmly mount the electrical connector on the circuit board and facilitating the operator to assemble the electrical connector. With the manufacturing method of the present disclosure, a hole penetrating in a thickness direction of the base portion is formed in the base portion by a reverse drawing process. The reverse drawing process is a technology that draws or shapes the metal material in a direction opposite to the forward stretching direction. Compared with traditional forward stretching, reverse stretching changes the flow direction of the metal, thereby optimizing material distribution and reducing defects during the shaping process.

In some embodiments, in order to adapt to the miniaturization requirements of the electrical connector, a special structural design is made for the top shell for the electrical connector. The raised portion of the top shell may be configured to comprise a front subportion, a rear subportion and a transition subportion, wherein a width of the front subportion is smaller than a width of the rear subportion, so that the front subportion may be used to accommodate an inner shell and a front part of the connector subassembly accommodated in the inner shell, while the rear subportion is used to accommodate a rear part of the connector subassembly. Dedicated chambers are provided for different parts of the connector subassembly to accommodate the different parts separately. In some embodiments, a more compact chamber is provided for the front part of the connector subassembly to provide a more miniaturized electrical connector, and at the same time a certain amount of mounting space may be reserved at the base portion on both sides of the front subportion; a larger chamber is provided for the rear part of the connector subassembly to provide mounting space for the wider rear part of the subassembly housing.

In some embodiments, within the limited space of a circuit board, in order to meet the requirement of allowing multiple mating devices (such as electronic devices) to interface with the electrical connector, the top shell is provided to comprise a plurality of raised portions configured to be spaced apart. For example, the raised portions are configured to be spaced apart in the length direction of the electrical connector, so that a plurality of electrical connectors can be configured side by side in the length direction within a limited space.

In some embodiments, in order to ensure better mechanical strength and durability of the electrical connector, the top shell can be made of stainless steel sheet of SUS316 or SUS304. SUS316 stainless steel contains molybdenum. Molybdenum may enhance the corrosion and pitting resistance of the top shell for the electrical connector, especially in environments containing chlorides and non-oxidizing acids. The metal sheet has a thickness in a range of 0.5 mm to 2.0 mm. Therefore, the top shell may have a thicker thickness and a stronger strength. However, there is a problem that thicker shells are difficult to weld. In some embodiments, the metal sheet is specially processed to provide a plurality of recesses on the upper surface of the raised portion of the top shell for the electrical connector (as described above), thereby allowing the shell to be welded. In some embodiments, the metal sheet forming the top shell for the electrical connector is first specially processed, and then the processed metal sheet is placed into a mold for stamping to form the shell.

In some embodiments, in order to provide good durability for the electrical connector and meet the strength required for the drop test, the raised portion of the top shell is formed by stretching and cold forging the stainless steel plate to realize a raised portion with a specific structure.

In some embodiments, the terminal assembly include terminals configured to establish pressure-mount electrical connections, and the terminal assembly is connected to the circuit board through pressure mount. Compared with ordinary surface mounting technology (SMT) welding, the terminal assembly has the advantage of being able to be replaced conveniently and quickly, and also reduces the defective rate caused by the SMT process. The terminal assembly is made of highly conductive material, and the material thickness may be in a range of 0.10 mm˜0.30 mm. The synchronization signal terminal (TXRX Pin) and the power terminal (VBUS & GND Pin) use terminals of different thicknesses, allowing to meet the requirements of high frequency and high current at the same time. In addition, each signal terminal may comprise an elastic bending portion provided with a slot to be aligned with the opening. This configuration can improve signal integrity.

In some embodiments, a shield of an electrical connector is provided to comprise a lug portion which extends beyond two opposite side portions of the rear end of the subassembly housing in the length direction of the electrical connector, and is adapted for connection with the top shell. On the one hand, the lug portion can provide a reliable fixation between the connector subassembly and the top shell. In some optional embodiments, the lug portion may be connected to the top shell by electric welding. On the other hand, the lug portion also has a position-limiting function to allow the rear part of the connector subassembly to be accurately positioned in the rear subchamber, thereby ensuring the reliability of the electrical connector in terms of mechanical and electrical connections while meeting the mechanical strength requirements of the shell.

In some embodiments, in order to accurately position the connector subassembly of the electrical connector, the electrical connector may comprise an inner shell adapted to connect with the top shell and the bottom shell, and the inner shell is configured to surround the tongue portion of the subassembly housing, thereby allowing the front part of the connector subassembly to be accurately positioned in the front subchamber, playing a position-limiting role. The inner shell is accommodated in one or more chambers formed by connecting the bottom shell and the top shell, the bottom shell is directly welded to the inner shell, and the inner shell is directly welded to the top shell, thereby ensuring that both the upper surface and the lower surface of the inner shell are welded, which is beneficial to improve the strength of the entire electrical connector and meet the strength requirements of torsion and drop tests. By the above design structure, the electrical connector can ensure that the electrical connector meets very high strength requirements, and the electrical connector is allowed to be welded, thereby further ensuring the reliability of the electrical connector in terms of mechanical and electrical connections.

In some embodiments, in order to further ensure a reliable mechanical connection between the inner shell and the plug of the electrical connector, the inner shell may comprise one or more stopping portions provided on an inner surface of the inner shell, and the stopping portion abuts against an end of a plug inserted into the electrical connector, so as to be able to fully contact the plug, which is beneficial to shielding and plays a role in improving high frequency. In addition, the design of the stopping portion allows the impact force to be dispersed on the shell during a drop test, thereby avoiding the connector subassembly from being damaged due to the force, resulting in functional failure. In addition, the inner shell may comprise one or more beams and/or one or more protrusions provided on an inner surface of the inner shell, and the plug inserted into the electrical connector is clamped by the beam, thereby providing a firm clamping force for the connector subassembly, firmly fixing the connector subassembly in the inner shell, and ensuring the reliability of the electrical connector in terms of mechanical and electrical connections.

Below, the electrical connector, the top housing of the electrical connector, and the manufacturing method according to some embodiments of the present application will be described in detail with reference to the accompanying drawings.

For clarity and conciseness of description, a mating direction X in which the connector assembly mates with a complementary device, a direction Y perpendicular to the mating direction X (e.g., the length direction Y of the electrical connector), and a direction Z perpendicular to both the mating direction X and the length direction Y (e.g., the height direction Z of the electrical connector) may be labeled in the drawings.

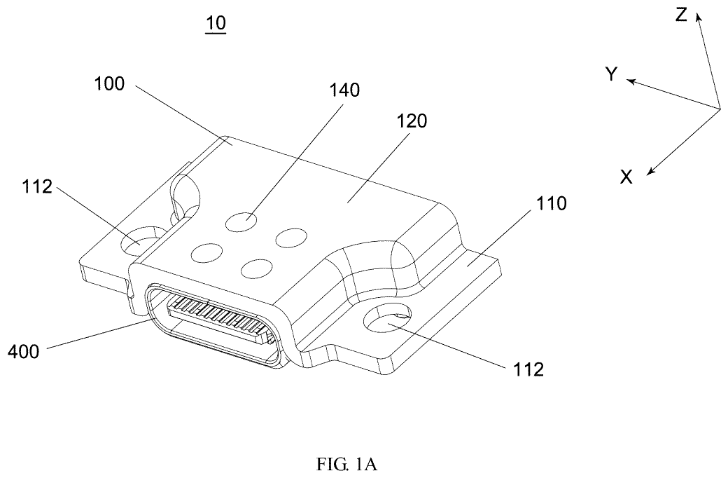

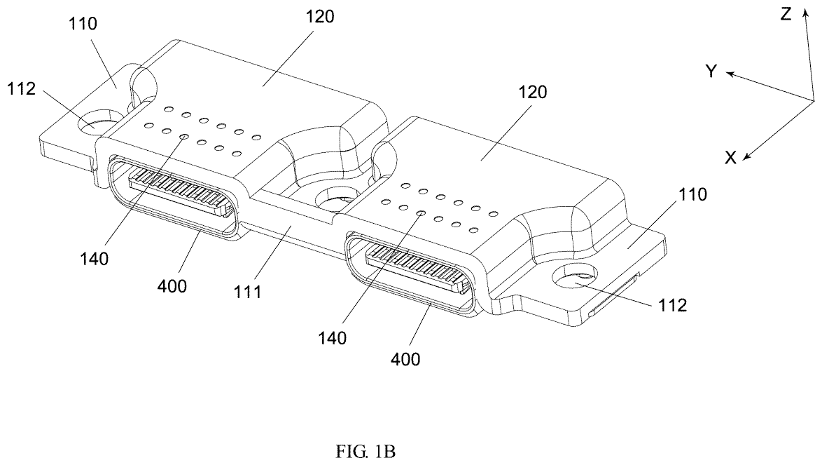

According to aspects of the present disclosure, a top shell 100 for an electrical connector 10 may be provided. The top shell 100 for the electrical connector 10 according to some embodiments is described in detail below with reference to FIGS. 1A to 4B.

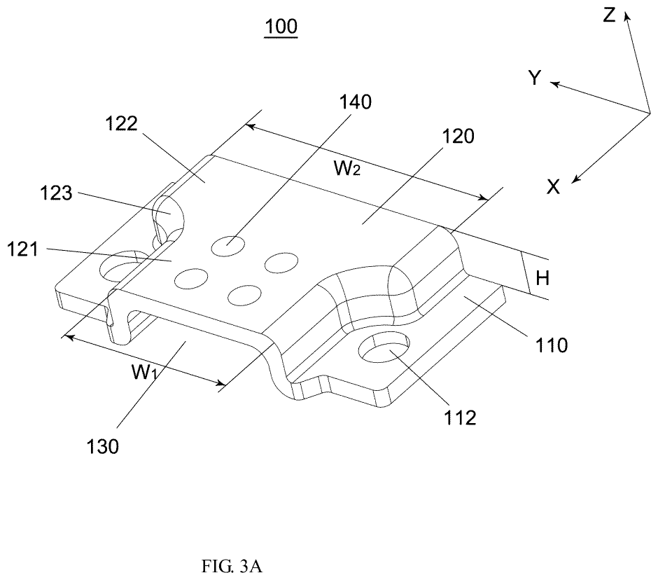

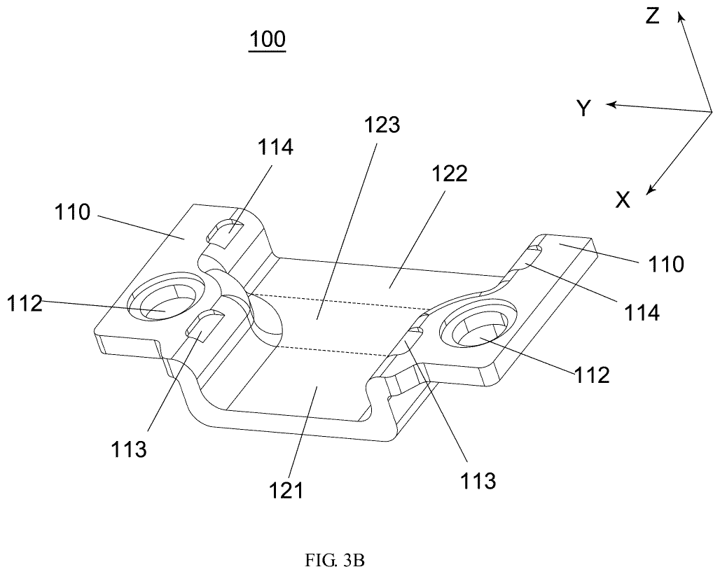

As shown in FIG. 3A, the top shell 100 for the electrical connector 10 may comprise a base portion 110 and a raised portion 120. The base portion 110 is adapted to connect with a circuit board; the raised portion 120 may protrude relative to the plane of the base portion 110 to form a chamber 130 for accommodating the inner shell 400 of the electrical connector 10. In some embodiments, the base portion 110 may extend in a plane parallel to the mating direction X of the electrical connector, and the raised portion may project upward from the base portion in the height direction Z of the electrical connector by a certain height.

The top shell is provided with a base portion configured to be connected to a circuit board, and a raised portion protruding from the base portion to form a chamber for accommodating an inner shell for the electrical connector. Such a configuration of the top shell enables the obtained electrical connector not only to be mounted above or below a circuit board, but also to be mounted in a belly-to-belly configuration. In the belly-to-belly configuration, one electrical connector is mounted above the circuit board, while another electrical connector is mounted below the circuit board and is substantially aligned with the electrical connector above the circuit board.

On one hand, by providing the raised portion, the top shell forms a chamber for accommodating the inner shell of the electrical connector, thereby ensuring the mechanical and electrical reliability of the electrical connector. On the other hand, such a configuration of the top shell is suitable not only for scenarios in which the connector is mounted above or below a circuit board, but also for scenarios in which the connector is mounted in a belly-to-belly configuration, thereby significantly increasing the flexibility of application scenarios for the electrical connector.

In some embodiments, as shown in FIG. 3A, an upper surface of the raised portion 120 may have a plurality of recesses 140.

The raised portion of the top shell is provided with a plurality of recesses on the upper surface of the raised portion. These recesses may be formed by specially processing the raw material used to form the top shell (for example, stainless steel plate) through methods such as corrosion, etching, laser processing, stamping and punching, or other shaping techniques, as a pre-treatment for the special structure of the mold. In this way, multiple recesses may be formed on the upper surface of the raised portion, reducing the thickness of the top shell at locations where the top shell is welded to the inner shell.

The formation of a plurality of recesses on the upper surface of the raised portion of the top shell facilitates spot welding between the top shell and the inner shell and enhances the joint strength between the top shell and the inner shell, thereby ensuring the reliability of the electrical connector in mechanical and electrical connections while meeting the mechanical strength requirements of the shell.

In some embodiments, a protruding height of the raised portion 120 may be equal to or less than 3.4 mm. As shown in FIG. 3A, the protruding height H that the raised portion protrudes from the plane of the base portion in the height direction Z of the electrical connector may be equal to or less than 3.4 mm. For example, the protruding height H may be 3.3 mm, 3.2 mm, 3.1 mm, 3.0 mm, 2.5 mm, 2.0 mm, etc.

The protruding height of the raised portion of the top shell may be equal to or less than 3.4 mm. In this way, the connector assembly may be mounted in application scenarios in different height spaces within a range of 3.4 mm above the circuit board to 3.4 mm below the circuit board, so that it can be suitable for various application scenarios, further improving the flexibility of the application scenarios of the electrical connector.

With continued reference to FIG. 3A, in some embodiments, the base portion 110 is formed with a hole 112 penetrating in a thickness direction of the base portion 110. In some embodiments, the hole 112 may be provided on both sides of the base portion along the length direction Y of the electrical connector. In some embodiments, threads may be formed on the inner wall face of the hole 112.

To further ensure the reliability of the mechanical connection, the present application may form the shell using a stamping mold. Accordingly, a hole penetrating in a thickness direction of the base portion may be provided in the base portion of the top shell. In some embodiments, a thread may be formed on an inner wall face of the hole, thereby helping to firmly mount the electrical connector on the circuit board and facilitating the operator to assemble the electrical connector.

In some embodiments, as shown in FIG. 3B, the raised portion 120 may comprise: a front subportion 121, a rear subportion 122, and a transition subportion 123 connecting the front subportion 121 and the rear subportion 122. Continuing with FIG. 3A, a width W1 of the front subportion 121 in the length direction Y of the electrical connector 10 may be less than a width W2 of the rear subportion 122 in the length direction Y of the electrical connector 10.

The raised portion of the top shell may be configured to comprise a front subportion, a rear subportion and a transition subportion. A width of the front subportion is smaller than a width of the rear subportion, so that the front subportion may accommodate an inner shell and a front part of the connector subassembly accommodated in the inner shell, while the rear subportion may accommodate a rear part of the connector subassembly. Dedicated chambers are provided for different parts of the connector subassembly to accommodate the different parts separately. In some embodiments, a more compact chamber is provided for the front part of the connector subassembly to provide a more miniaturized electrical connector, while also leaving installation space on both sides of the base portion adjacent to the front subportion. A larger chamber is provided for the rear part of the connector subassembly to accommodate the wider rear part of the subassembly housing.

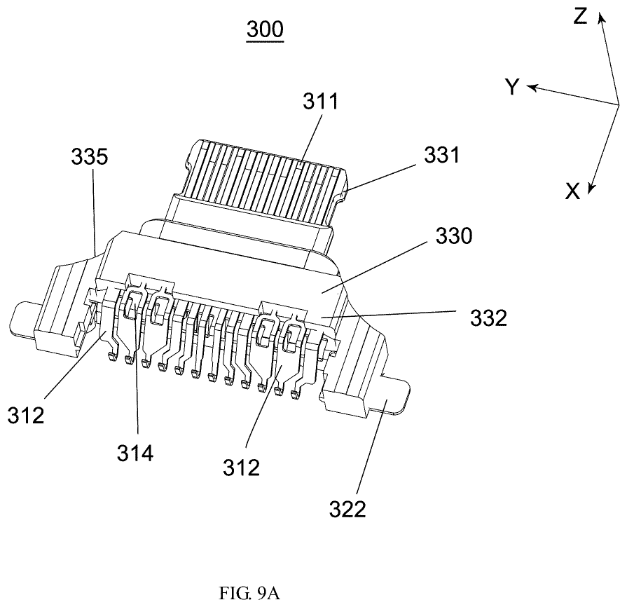

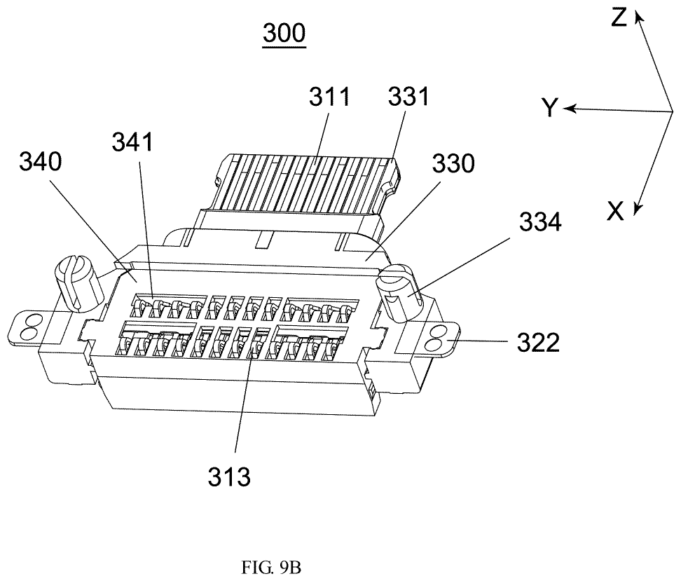

As shown in FIG. 3A, the transition subportion 123 has a shape that tapers from the rear subportion 122 to the front subportion 121, thereby matching the arc transition portion 335 of the subassembly housing 330 (referring to FIG. 9A), further ensuring a reliable mechanical connection between the top shell and the subassembly housing. In addition, the stress concentration in case of drops of the electrical connector is reduced, and the cooperation between the transition subportion and the arc transition portion can disperse the impact force on the top shell, thereby avoiding the connector subassembly from being damaged due to the force, resulting in functional failure.

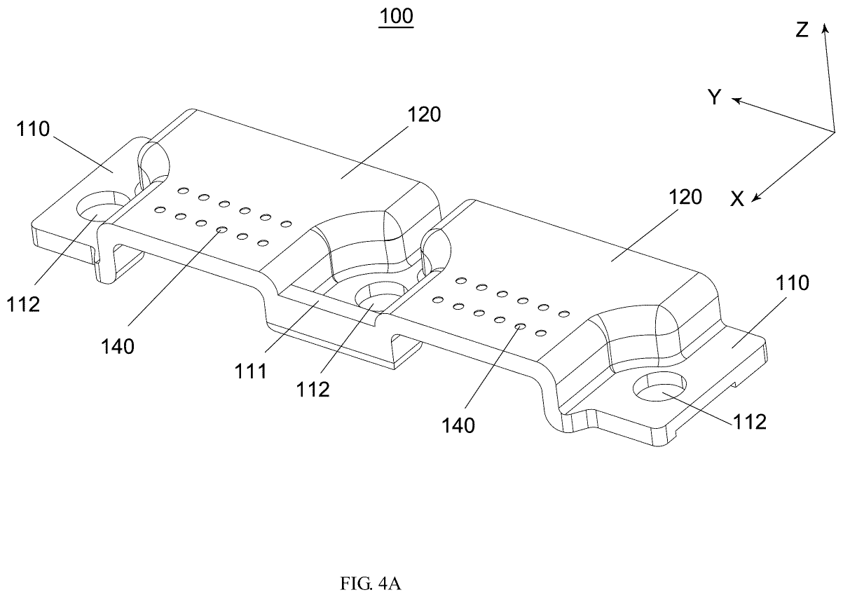

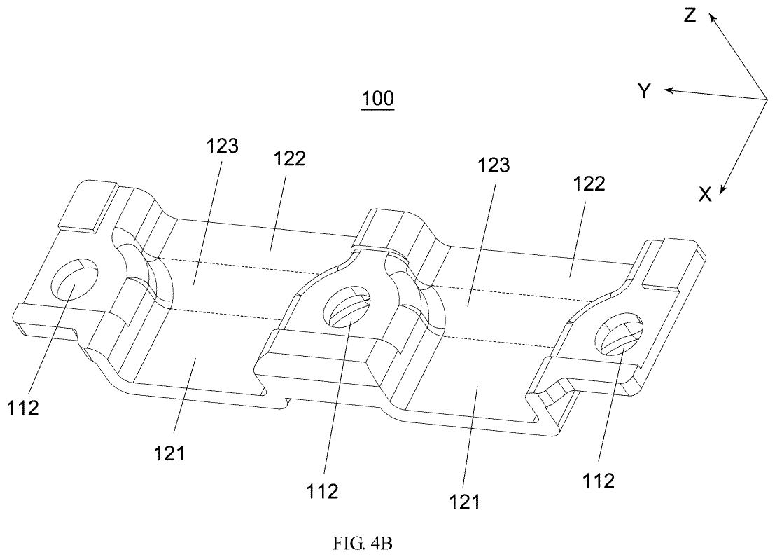

In some embodiments, as shown in FIG. 4A, the top shell 100 for the electrical connector 10 may comprise a plurality of raised portions 120 configured to be spaced apart from each other. In some embodiments, all of the plurality of raised portions 120 may have an identical structure.

The raised portions of the top shell are configured spaced apart in a length direction, so that a plurality of electrical connectors can be configured side by side in the length direction within a limited space.

In some embodiments, as shown in FIG. 3A, a base portion 110 may be formed on both sides of the raised portion 120 in the length direction Y of the electrical connector 10, and one or more holes 112 may be formed on each base portion 110. Although only one hole is formed on each side of the length direction Y of the electrical connector 10 shown in FIG. 3A, those skilled in the art will appreciate that, according to actual needs, more than one hole may be formed on each side of the length direction Y of the electrical connector 10 to further enhance the reliability of mechanical and electrical connections.

Referring to FIG. 4A below, in some embodiments, a rib 111 extending along the length direction Y of the electrical connector 10 may be formed on the base portion 110 between every two of the raised portions 120. In the top shell, one or more holes are formed on each of the base portions, so that the electrical connector can be firmly mounted on a circuit board through the holes on the base portion. In addition, a rib extending along a length direction of the electrical connector is formed on the base portion between every two of the raised portions, thereby further ensuring reliability in terms of mechanical and electrical connections.

In some embodiments, the top shell 100 may be made of a stainless steel sheet of SUS316 or SUS304. The top shell may be made of stainless steel of SUS316 or SUS304. SUS316 stainless steel contains molybdenum. Molybdenum may enhance the corrosion and pitting resistance of the top shell for the electrical connector, especially in environments containing chlorides and non-oxidizing acids.

In some embodiments, the stainless steel sheet may have a thickness in a range of 0.5 mm to 2.0 mm. The top shell may have a thicker thickness and a stronger strength. The metal sheet is specially processed (e.g., forming a plurality of recesses as described above) to allow the shell to be welded. In some embodiments, the metal sheet forming the top shell for the electrical connector is first specially processed, and then the processed metal sheet is placed in a mold for stamping to form the shell, such that the problem of difficulty in welding a thicker shell is overcome.

In some embodiments, the raised portion 120 may be formed by stretching and cold forging a stainless steel plate. With the top shell, a raised portion with a specific structure may be realized by stretching and cold forging processes, such that good durability is provided and the strength required for the drop test is met.

According to aspects of the present disclosure, an electrical connector 10 may be provided. The electrical connector 10 is described in detail below in conjunction with FIG. 1A to FIG. 10B.

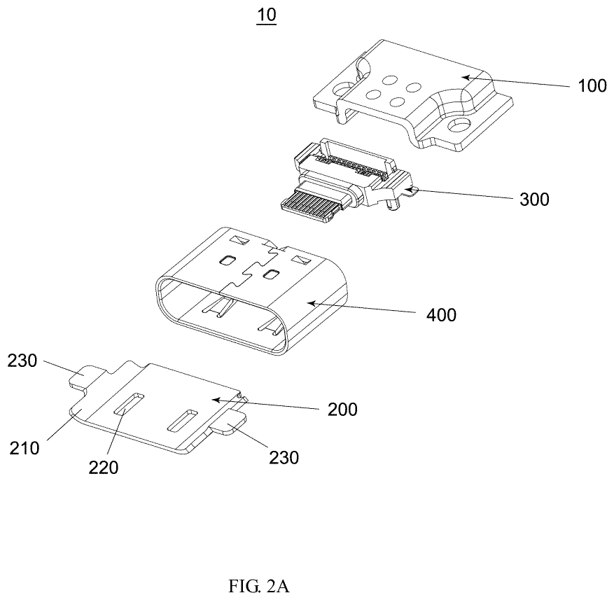

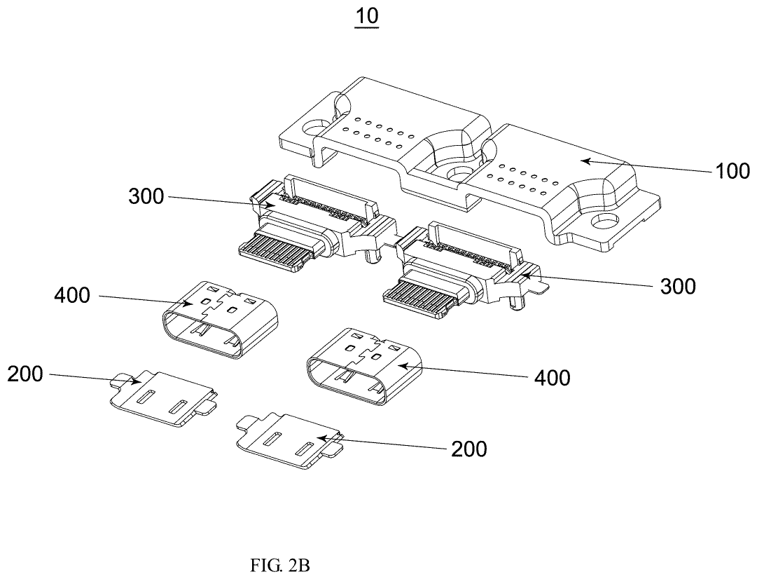

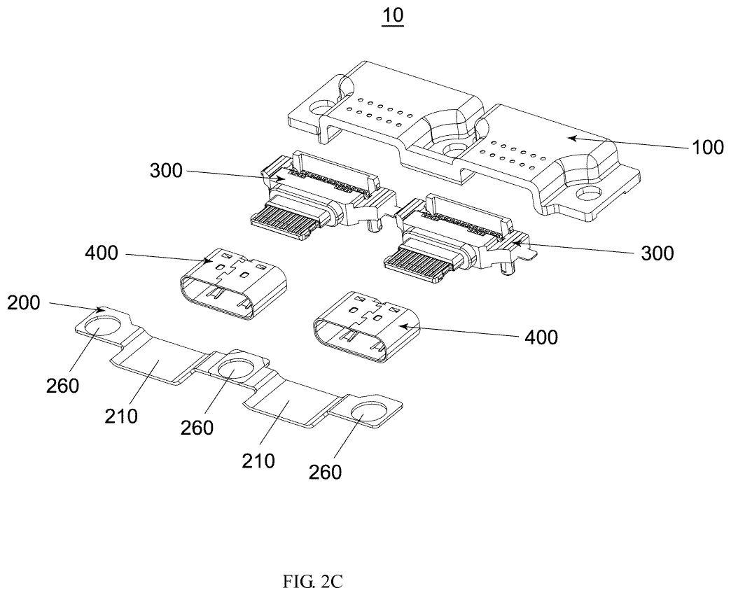

Referring to FIGS. 2A to 2C, the electrical connector 10 may comprise a top shell 100, a bottom shell 200, and a connector subassembly 300. The bottom shell 200 may be connected to the top shell 100 to form one or more chambers. The connector subassembly 300 may be accommodated in the chamber.

With the electrical connector of the present disclosure, a top shell and a bottom shell are provided, and the bottom shell is connected to the top shell to form one or more chambers to accommodate the connector subassembly, such that a plurality of electrical connectors can be configured side by side in a limited space.

In some embodiments, each of the one or more chambers may comprise a front subchamber and a rear subchamber. The front subchamber may be formed by enclosing the inner surface of the front subportion 121 and the upper surface of the bottom shell 200 together. The rear subchamber may be formed by the inner surface of the rear subportion 122.

With the electrical connector of the present disclosure, each chamber is provided to comprise a front subchamber and a rear subchamber. The front subchamber is formed by enclosing an inner surface of the front subportion and an upper surface of the bottom shell together, and the rear subchamber is formed by an inner surface of the rear subportion, thereby allowing dedicated chambers to be provided for different parts of the connector subassembly to accommodate different parts separately. In some embodiments, a more compact chamber (e.g., a front subchamber) is provided for the front part of the connector subassembly to provide a more miniaturized electrical connector, and at the same time a certain amount of mounting space may be reserved at the base portion on both sides of the front subportion; a larger chamber (e.g., a rear subchamber) is provided for the rear part of the connector subassembly to provide mounting space for the wider rear part of the subassembly housing.

In some embodiments, as shown in FIG. 1B, a base portion 110 may be formed on both sides of each of the one or more chambers in the length direction Y of the electrical connector 10, and one or more holes 112 may be formed on each base portion 110, so that the electrical connector can be firmly mounted on the circuit board through the holes on the base portion. In some embodiments, as shown in FIG. 1B, a rib 111 extending along the length direction Y of the electrical connector 10 may be formed on the base portion 110 between every two of the raised portions 120, thereby further ensuring reliability in terms of mechanical and electrical connections.

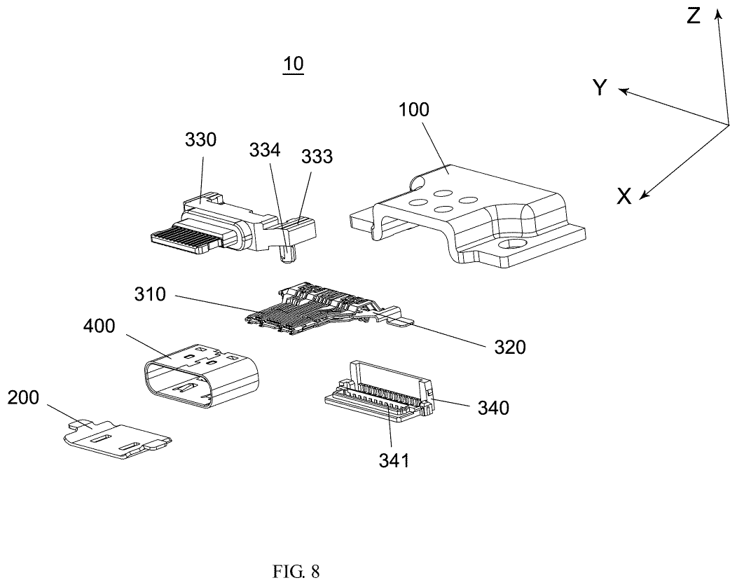

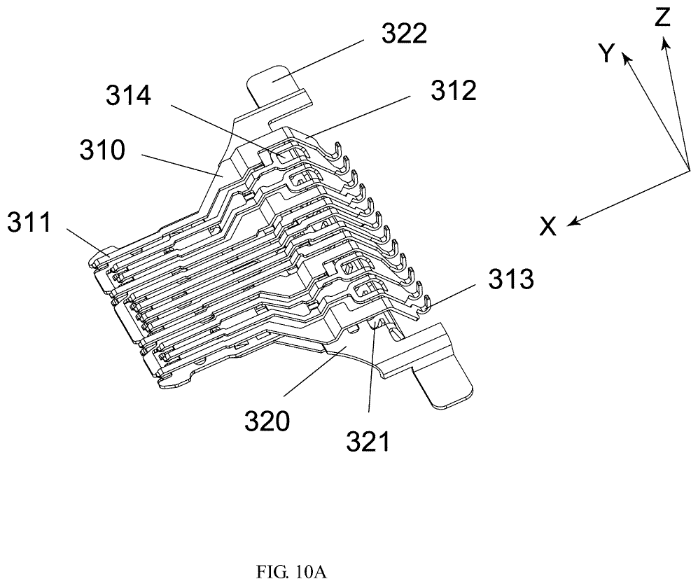

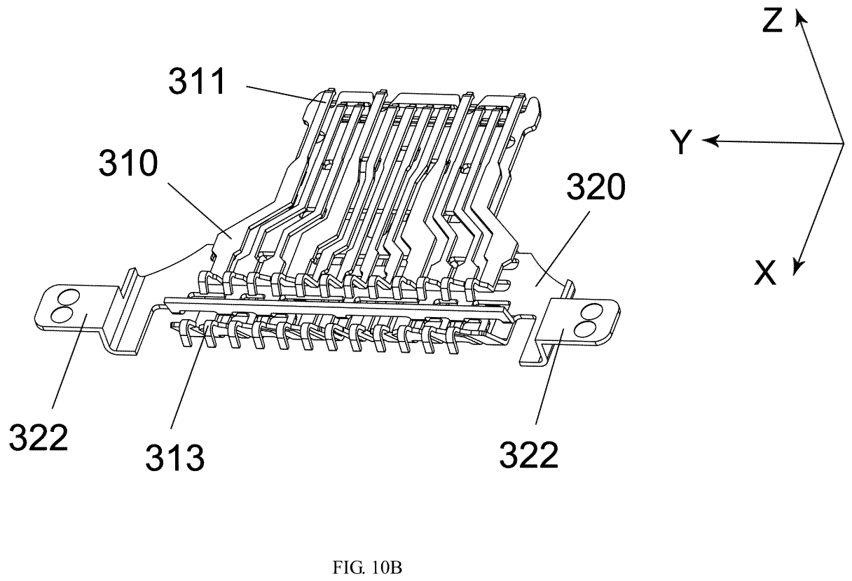

The connector subassembly 300 of the electrical connector 10 will be described below in conjunction with FIG. 8 to FIG. 10B. In some embodiments, as shown in FIG. 8, the connector subassembly 300 may comprise a terminal assembly 310. As shown in FIG. 10A, the terminal assembly 310 may comprise a plurality of terminals provided spaced apart along a length direction Y of the electrical connector 10. The plurality of terminals may be configured to establish pressure-mount electrical connections, as shown in FIG. 10A.

The terminal assembly include terminals configured to establish pressure-mount electrical connections, and the terminal assembly may be connected to the circuit board through pressure mount. The terminal assembly has the advantage of being able to be replaced conveniently and quickly, and also reduces the defective rate caused by the SMT process. The terminal assembly may be made of highly conductive material, and the material thickness may be in a range of 0.10 mm˜0.30 mm. The synchronization signal terminal (TXRX Pin) and the power terminal (VBUS & GND Pin) use terminals of different thicknesses, allowing to meet the requirements of high frequency and high current at the same time.

In some embodiments, as shown in FIG. 8, the connector subassembly 300 may further comprise a shield 320 and a subassembly housing 330. The subassembly housing 330 may be configured to accommodate a plurality of terminals and the shield 320.

As shown in FIGS. 10A and 10B, in some embodiments, the plurality of terminals may comprise mating ends 311 and tail ends 312. In some embodiments, the tail ends 312 may each be provided with an elastic bending portion 313 which protrudes towards a direction opposite to the top shell 100 in such a manner that the elastic bending portion can be elastically deformed in a protruding direction of the raised portion 120.

Referring to FIG. 9A, in some embodiments, the mating ends 311 of the plurality of terminals may be provided on a tongue portion 331 of the subassembly housing 330, and are provided in two rows along a protruding direction of the raised portion 120. The tail ends 312 of the plurality of terminals may extend beyond the rear end 332 of the subassembly housing 330.

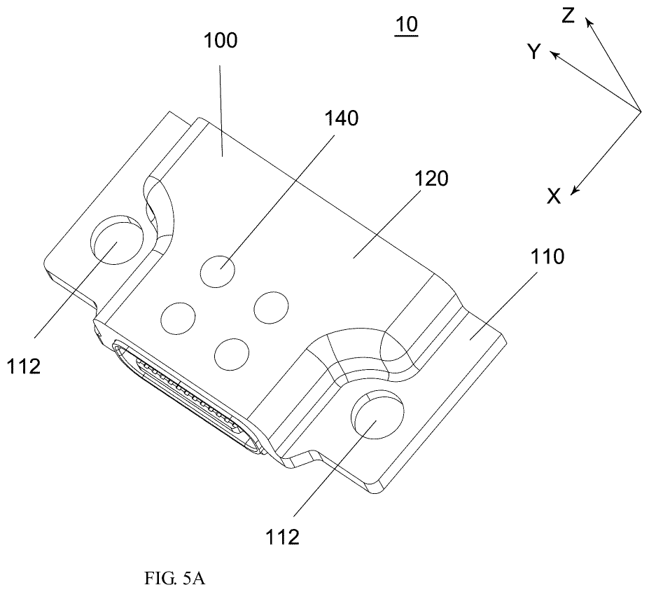

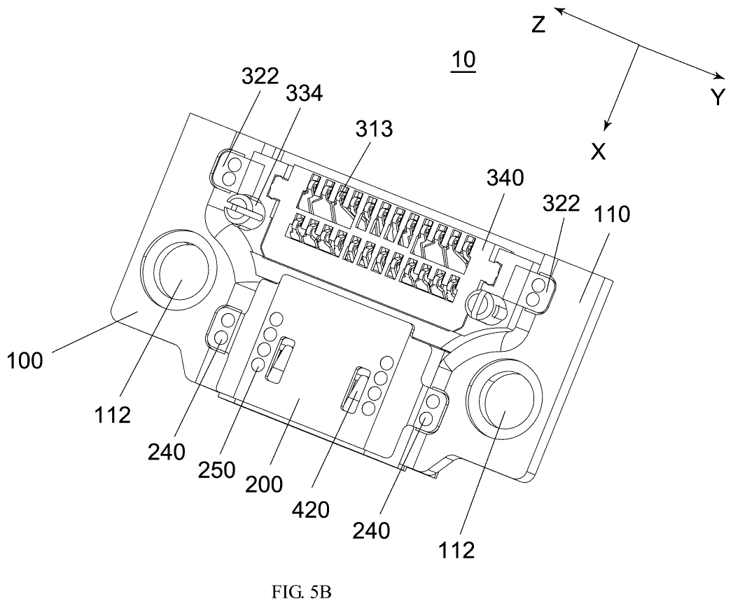

In some optional embodiments, the terminal assembly 310 may comprise one or more rows of terminals provided spaced apart in the height direction Z of the electrical connector. As shown in FIGS. 10A and 10B, the terminal assembly 310 may comprise two rows of terminals provided spaced apart in the height Z direction. As shown in FIG. 8, the connector subassembly 300 may further comprise an organizer 340, which may comprise one or more rows of channels 341 (as shown in FIG. 9B) for accommodating the terminal assembly 310. The organizer 340 may be connected to the subassembly housing 330. As shown in FIG. 8, the subassembly housing 330 may comprise a mating structural member 333 for receiving the organizer 340. In some embodiments, as shown in FIGS. 5B, 6B and 9B, one or more protrusions 334 are provided on both sides of the mating structural member 333 for connection with the circuit board, thereby ensuring both the precise positioning of the electrical connector and the circuit board and the reliable mechanical connections between the electrical connector and the circuit board.

Referring to FIG. 10A below, In some embodiments, the elastic bending portion 313 of one or more of the plurality of terminals may be provided with a slot 314; a opening 321 may be formed on the shield 320, and when the terminal assembly 310 and the shield 320 are mounted on the subassembly housing 330, the slot 314 may be aligned with the opening 321. Each signal terminal may comprise an elastic bending portion provided with a slot to be aligned with the opening. This configuration can improve signal integrity.

In some embodiments, as shown in FIG. 10A, the shield 320 may comprise a lug portion 322, which extends beyond two opposite side portions of the rear end 332 of the subassembly housing 330 in the length direction Y, and is adapted for connection with the top shell 100, as shown in FIG. 5B. Referring back to FIG. 3B, the base portion 110 of the top shell 100 may be provided with a mating rear recess 114 on both sides near the rear subportion 122 for connection with the lug portion 322 of the shield 320, thereby ensuring both precise positioning of the rear part of the connector subassembly with the rear subchamber of the top shell and reliable mechanical and electrical connections of the electrical connector.

In the related art, the connection is made through a snap-fit design. The shell is relatively thick, and thus the shield is provided to comprise a lug portion, which extends beyond two opposite side portions of the rear end of the subassembly housing in the length direction, and is adapted for connection with the top shell. On the one hand, the lug portion can provide a reliable fixation between the connector subassembly and the top shell. In some optional embodiments, the lug portion may be connected to the top shell by electric welding. On the other hand, the lug portion also has a position-limiting function to allow the rear part of the connector subassembly to be accurately positioned in the rear subchamber.

With continued reference to FIG. 8, In some embodiments, the connector subassembly 300 may further comprise an inner shell 400 adapted to connect with the top shell 100 and the bottom shell 200. The inner shell 400 is configured to surround the tongue portion 331 of the subassembly housing 330, thereby allowing the front part of the connector subassembly to be accurately positioned in the front subchamber, thereby playing a limiting role. In some embodiments, the connector subassembly 300 may have a mating interface that complies with the USB Type-C standard.

In some embodiments, the inner shell 400 may be accommodated in the chamber, and may be welded to the raised portion 120 and the bottom shell 200 constituting the chamber.

The inner shell is accommodated in the chamber, the bottom shell is directly welded to the inner shell, and the inner shell is directly welded to the top shell, thereby ensuring that both the upper surface and the lower surface of the inner shell are welded, which is beneficial to improve the strength of the entire electrical connector and meet the strength requirements of torsion and drop tests. By the above design structure, the electrical connector of the present disclosure can ensure that the electrical connector meets very high strength requirements, and the electrical connector is allowed to be welded, thereby further ensuring the reliability of the electrical connector in terms of mechanical and electrical connections.

The bottom shell 200 of the electrical connector 10 will be described below in conjunction with FIGS. 2A to 2C and 5B. As shown in FIG. 2A, the bottom shell 200 may comprise a main surface 210 for carrying the inner shell 400. The size of the main surface 210 may be substantially equal to the size of the surface that the inner shell 400 contacts the main surface. In some embodiments, the main surface 210 is formed with bent portions on both sides in the length direction Y of the electrical connector to mate the shape of the inner shell 400.

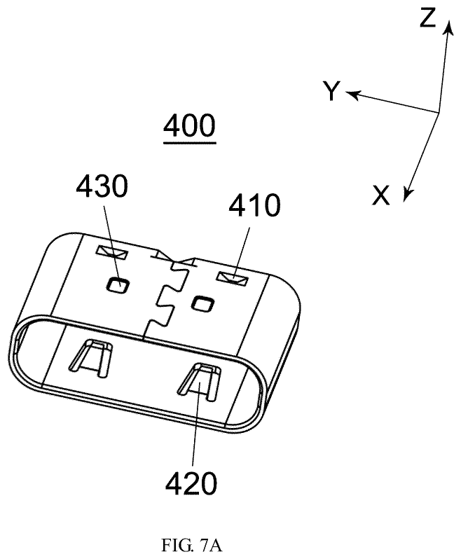

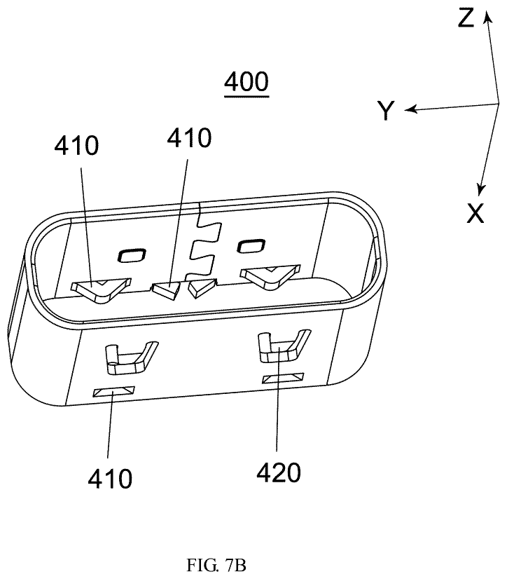

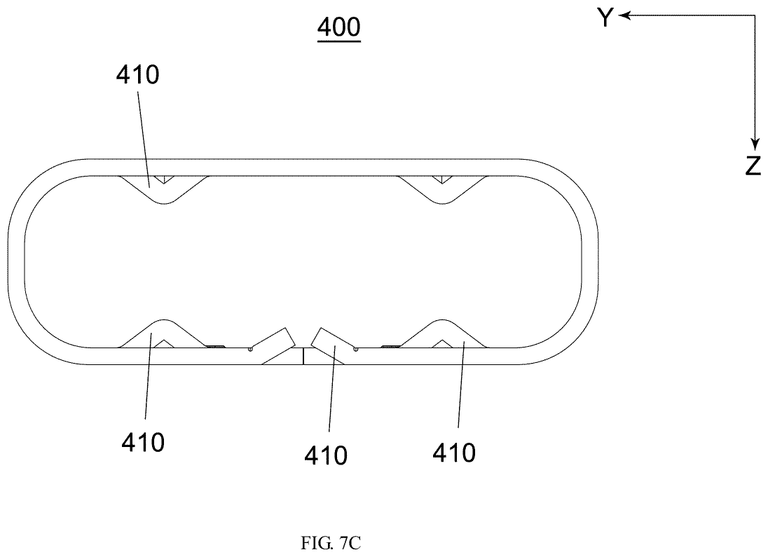

In some embodiments, as shown in FIGS. 2A and 5B, a through via 220 having a size adapted to the beam 420 (as shown in FIGS. 7A and 7B) formed on the inner shell 400 can be formed on the main surface of the bottom shell 200 to provide sufficient elastic space to allow the beam to clamp the connector subassembly 300 tightly.

With continued reference to FIG. 2A, the main surface of the bottom shell 200 is formed with lug portions 230 of the bottom shell on both sides in the length direction Y of the electrical connector. In some embodiments, as shown in FIG. 5B, one or more recesses 240 may be provided on the lug portion 230 of the bottom shell, and is adapted for connection with the top shell 100. For example, the lug portion 230 of the bottom shell may be connected to the top shell 100 by electric welding. In this embodiment, the base portion 110 of the top shell 100 may be provided with a mating front recess 113 (as shown in FIG. 3B) on both sides near the front subportion 121 for connection with the lug portion 230 of the bottom shell, thereby ensuring both precise positioning of the bottom shell and the top shell and reliable mechanical and electrical connections.

Referring next to FIG. 2C, in some further embodiments, the bottom shell 200 may comprise two or more main surfaces 210 for carrying the inner shell 400. In such an embodiment, the plurality of main surfaces 210 may be configured to be spaced apart from each other. Holes 260 are formed on both sides of the main surface 210 of the bottom shell 200 in the length direction Y. The shape and size of the holes 260 match the holes 112 so as to fix the top shell and the bottom shell together to the circuit board by thread connection.

Referring to FIG. 5B, in some embodiments, the main surface of the bottom shell 200 may comprise one or more recesses 250 for connection with the top shell 100, thereby further ensuring the reliability of the electrical connector in terms of mechanical and electrical connections. For example, the bottom shell 200 may be connected to the top shell 100 by electric welding via the recess 250 of the top shell.

The inner shell 400 of the electrical connector 10 is described below in conjunction with FIGS. 7A to 7C. In some embodiments, as shown in FIGS. 7A to 7B, the inner shell 400 may comprise one or more stopping portions 410 provided on an inner surface of the inner shell 400, and the stopping portion 410 abuts against an end of a plug inserted into the electrical connector 10, so as to be able to full contact the plug, which is beneficial to shielding, and plays a role in improving high frequency. In addition, the design of the stopping portion allows the impact force to be dispersed on the shell during a drop test, thereby avoiding the connector subassembly from being damaged due to the force, resulting in functional failure.

Continued as shown in FIGS. 7A to 7B, in some optional embodiments, the inner shell 400 may comprise one or more beams 420 and/or one or more protrusions 430 provided on the inner surface of the inner shell 400, and the plug inserted into the electrical connector 10 is clamped by the beams 420, thereby providing a firm clamping force to the connector subassembly, firmly fixing the connector subassembly in the inner shell, and ensuring the reliability of the electrical connector in terms of mechanical and electrical connections. The protrusions 430 may engage with the subassembly housing 330, thereby reducing the risk of relative movements between the subassembly housing 330 and the inner shell 400.

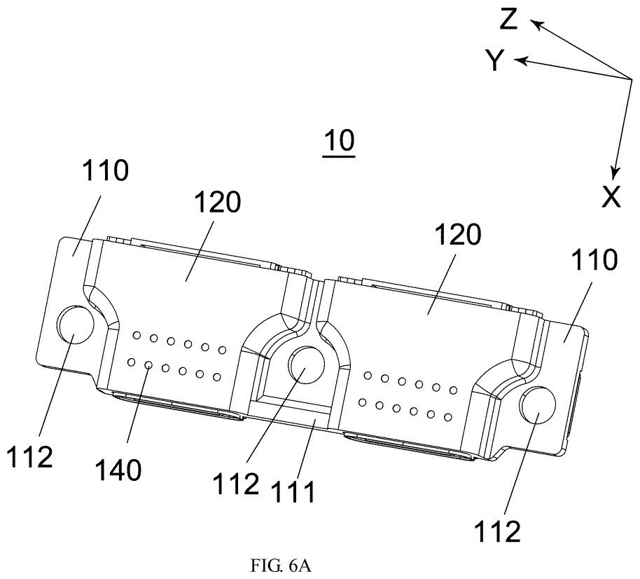

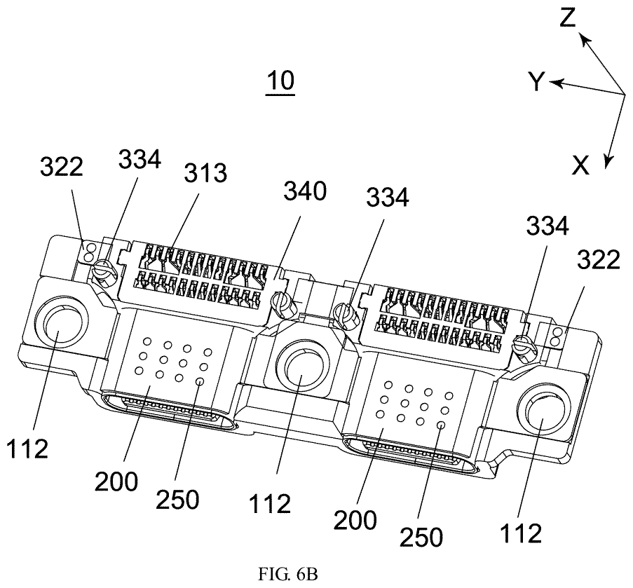

The assembly process of the electrical connector will be described below with reference to FIGS. 8, 9A and 9B, 2A, 5B, and 6B. The shield 320 is inserted by a robot arm into the chamber of the subassembly housing 330 in an appropriate position, so that the shield 320 is fixed in the subassembly housing 330. Then, the mating ends of the terminals located in the lower row and the upper row (relative to the height direction Z) are respectively passed through the chamber of the subassembly housing 330 and fixed in the tongue portion 331 (as shown in FIG. 9A) by a robot arm, and then the organizer 340 is mounted to the rear end 332 of the subassembly housing 330, so that the elastic bending portions of the plurality of terminals are exposed from the channels of the organizer 340 (as shown in FIG. 9B) , thereby obtaining the connector subassembly 300 (as shown in FIG. 2A). The connector subassembly 300 is inserted into the chamber of the inner shell 400, precisely positioned by the stopping portion 410 provided on the inner shell, and firmly clamped by the protrusion 430 on the inner shell, and then the inner shell 400 accommodating the connector subassembly 300 is mounted on the top shell 100. Specifically, the inner shell and the top shell can be directly welded by welding. The lug portion 322 of the shield 320 is mounted (e.g., by welding) to the rear recess 114 of the top shell. However, the bottom shell is mounted (e.g., by welding) to the inner shell. In the embodiment shown in FIG. 5B, the bottom shell can be mounted to the top shell by welding through a recess 250 (as shown in FIG. 2C) provided on the surface of the bottom shell and a recess 240 (as shown in FIG. 2C) provided on a lug portion on both sides of the bottom shell, thereby obtaining an assembled electrical connector, which can be a single electrical connector (as shown in FIG. 1A, FIG. 5A, and FIG. 5B) or an electrical connector configured side by side (as shown in FIG. 1B). Alternatively, in the embodiment shown in FIGS. 6A and 6B, the bottom shell can be mounted to the top shell by welding through a recess 250 provided on the surface of the bottom shell, and fixed by means of a thread connection through a hole 260 provided on the surface of the bottom shell (as shown in FIG. 2C, matching the hole 112 on the top shell), thereby obtaining an assembled electrical connector, which can be electrical connectors configured side by side (as shown in FIG. 6B) or a separate electrical connector (not shown). Finally, the assembled electrical connector is mounted (e.g., by screwing) on the circuit board. The electrical connector can ensure reliability and durability in terms of mechanical and electrical connections while ensuring flexibility in application scenarios.

According to aspects of the present disclosure, a method of manufacturing a top shell 100 for an electrical connector 10 may be provided. The method may comprise: providing a metal sheet; stamping a processed metal sheet to form a top shell 100 having a base portion 110 and a raised portion, wherein the raised portion 120 protrudes from the plane of the base portion 110 to form a chamber 130 for accommodating an inner shell 400 of the electrical connector 10.

With the top shell having a base portion and a raised portion obtained by the manufacturing method of the present disclosure, the raised portion protrudes from the base portion to form a chamber for accommodating an inner shell for an electrical connector. Thus, the obtained electrical connector can be mounted not only above or below a circuit board, but also in a circuit board of a belly-to-belly configuration. In the belly-to-belly configuration, one electrical connector is mounted above the circuit board, while another electrical connector is mounted below the circuit board and is substantially aligned with the electrical connector above the circuit board.

On the one hand, with the top shell for the electrical connector obtained by the manufacturing method of the present disclosure, a raised portion is formed to thus form a chamber for accommodating the inner shell for the electrical connector, thereby ensuring the reliability of the electrical connector in terms of mechanical and electrical connections. On the other hand, such a configuration of the top shell for the electrical connector obtained by the manufacturing method of the present disclosure is suitable for both scenarios in which it is mounted above or below a circuit board and scenarios in which it is mounted in a belly-to-belly configuration, thereby significantly increasing the flexibility of application scenarios for the electrical connector.

In some embodiments, the metal sheet is a stainless steel sheet, and the metal sheet has a thickness ranging from 0.5 mm to 2.0 mm. The top shell may have a thicker thickness and a stronger strength. The metal sheet is specially processed to allow the shell to be welded. With the top shell, the metal sheet is firstly specially processed, and then the processed metal sheet is placed into a mold for stamping to form the shell.

In some embodiments, the method may further comprise processing the raised portion 120 to form a recess 140 on the raised portion 120.

In some embodiments, the metal sheet may be processed by corrosion, etching, laser processing, stamping and punching, punching and/or other shaping techniques to form a plurality of recesses 140 on the metal sheet. With the method of manufacturing the top shell for the electrical connector of the present disclosure, the metal sheet is processed by methods of corrosion, etching, laser processing, stamping and punching and/or other shaping processing to form the plurality of recesses on the metal sheet. In the related art, when the shell for the electrical connector is made thicker in order to meet the mechanical strength requirement, there is a problem of difficulty in welding. With the method of manufacturing the top shell for the electrical connector of the present disclosure, a plurality of recesses may be formed on the upper surface of the raised portion by special processes, which facilitates spot welding between the top shell and the inner shell and enhances the joint strength between the top shell and the inner shell, thereby ensuring the reliability of the electrical connector in mechanical and electrical connections while meeting the mechanical strength requirements of the shell.

In some embodiments, a protruding height of the raised portion 120 may be equal to or less than 3.4 mm. A protruding height of the raised portion of the top shell for the electrical connector obtained by the manufacturing method of the present disclosure can be equal to or less than 3.4 mm. In this way, the obtained electrical connector may allow to be mounted in application scenarios in different height spaces within a range of 3.4 mm above the circuit board to 3.4 mm below the circuit board, so that it can be suitable for various application scenarios, further improving the flexibility of the application scenarios of the electrical connector.

In some embodiments, a hole 112 penetrating in the thickness direction of the base portion 110 is formed in the base portion 110 through a reverse stretching process, and a thread is formed on the inner wall face of the hole 112. The reverse drawing process is a technology that draws or shapes the metal material in a direction opposite to the forward stretching direction. Compared with traditional forward stretching, reverse stretching changes the flow direction of the metal, thereby optimizing material distribution and reducing defects during the shaping process.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to right angle connectors. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear”, “upper”, “lower”, “left”, “right”, “transverse direction”, “vertical direction”, “perpendicular”, “horizontal”, “top”, “bottom” and the like are shown based on the accompanying drawings, for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation.

It should be noted that the terms used herein are for describing specific embodiments, and are not intended to limit the exemplary embodiments according to the present disclosure. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A shell for a connector, comprising:
a base portion configured to mount to a circuit board; and
a raised portion having a height with respect to the base portion, the raised portion comprising one or more recesses configured for joining with an inner shell of the connector.

2. The shell of claim 1, wherein:
the height is in a range of 2.4 mm to 3.4 mm.

3. The shell of claim 1, wherein:
the raised portion comprises a front subportion having a first width in a direction perpendicular to a mating direction of the connector, and a rear subportion having a second width in the direction perpendicular to the mating direction of the connector, the first width greater than the first width, a transition subportion connecting the front subportion and the rear subportion.

4. The shell of claim 3, wherein:
the raised portion is a first raised portion; and
the shell comprises a second raised portion separated from the first raised portion by a subportion of the first raised portion.

5. The shell of claim 4, wherein:
the subportion of the base portion comprises a threaded hole.

6. The shell of claim 4, wherein:
the subportion of the base portion comprises a rib connecting the first raised portion and the second raised portion.

7. The shell of claim 1, wherein:
the shell comprises stainless steel having a thickness in a range of 0.5 mm to 2.0 mm.

8. The shell of claim 7, wherein:
the shell is thinner at the one or more recesses than non-recessed portions.

9. An electrical connector comprising:
a top shell comprising a base portion and a raised portion protruding from the base portion;
a bottom shell connected to the base portion of the top shell;
a chamber between the raised portion and the bottom shell; and
a connector subassembly disposed in the chamber.

10. The electrical connector of claim 9, wherein:
the connector subassembly comprising a mating interface compliant with a USB Type-C standard in effect on or before the priority date of the present disclosure.

11. The electrical connector of claim 9, wherein the connector subassembly comprises a terminal assembly comprising:
a plurality of terminals, each of the plurality of terminals comprising a mating end, a contact tail configured to establish pressure-mount electrical connections, and an intermediate portion between the mating end and the contact tail;
a shield; and
a subassembly housing holding the plurality of terminals and the shield.

12. The electrical connector of claim 11, wherein:
the plurality of terminals comprise one or more signal terminals; and
the intermediate portion of each of the one or more signal terminals comprises a slot aligned with an opening of the shield.

13. The electrical connector of claim 11, wherein:
the shield comprises a lug portion extending beyond the subassembly housing and disposed between and joined with the base portion of the top shell and the bottom shell.

14. The electrical connector of claim 11, wherein:
the connector subassembly comprises an inner shell surrounding at least the mating ends of the plurality of terminals; and
the inner shell is disposed between and joined with the raised portion of the top shell and the bottom shell.

15. The electrical connector of claim 14, wherein:
the inner shell is welded to the raised portion of the top shell and the bottom shell at selected locations.

16. The electrical connector of claim 14, wherein:
the inner shell comprises one or more protrusions engaging with the subassembly housing of the terminal assembly, and one or more beams configured to abut against a mating component to the terminal assembly.

17. A method for manufacturing a shell for a connector, the method comprising:
providing a metal sheet;
processing the metal sheet to form one or more recesses on the metal sheet; and
stamping the processed metal sheet into the shell comprising a base portion and a raised portion spaced from the base portion and connected to the base portion on at least two sides.

18. The method of claim 17, wherein:
the metal sheet is a stainless steel sheet having a thickness in a range of 0.5 mm to 2.0 mm.

19. The method of claim 17, wherein:
the metal sheet is processed by corrosion, etching, laser processing, and/or stamping and punching to form the one or more recesses.

20. The method of claim 17, comprising:
forming a threaded hole in the base portion of the shell.
